(19) United States
(12) Patent Application Publication
(10) Pub. No.: US 2026/0289485 A1
(43) Pub. Date: Sep. 24, 2026

(54) COMPUTER-IMPLEMENTED METHOD FOR AUTOMATICALLY MONITORING A LOGISTICS NETWORK, MONITORING SYSTEM, COMPUTER PROGRAM AND METHOD FOR TRAINING A NEURAL NETWORK

(71) Applicant: Körber Supply Chain Logistics GmbH, Konstanz (DE)

(72) Inventor: Dominik Sacha, Überlingen (DE)

(21) Appl. No.: 19/471,799

(22) PCT Filed: Mar. 14, 2024
(86) PCT No.: PCT/EP2024/056749

§ 371 Date: Oct. 2, 2025

(30) Foreign Application Priority Data
Apr. 3, 2023 (DE) 10 2023 108 515.8

(51) Int. Cl. G06Q 10/0833; G06Q 10/083

(52) U.S. Cl. CPC G06Q 10/0833; G06Q 10/08355

(57) ABSTRACT

A computer-implemented method for automatically monitoring a logistics network for processing mail items, including receiving or determining network properties of the logistics network, receiving or determining at least one actual operating value of the logistics network, and determining an anomaly value based on the at least one actual operating value and the network properties.

### BACKGROUND

The invention relates to a computer-implemented method for automatically monitoring a logistics network for processing mail items, a monitoring system, a computer program and a method for training a neural network for anomaly detection in a logistics network for mail items.

A logistics network for mail items can be used to process mail items. For example, such logistics networks are provided in letter and parcel centers. Furthermore, a logistics network can also include several letter and parcel centers and possibly other areas of the logistics chain up to a recipient. During operation, a logistics network of this type has to process a large number of mail items in a very short time. Logistics networks can be individually designed and adapted to different areas of application. Different logistics networks can vary in structure and scope. The variation can depend, for example, on the respective provider or company that operates the logistics network, the country in which the logistics network is located, a hierarchy of a system in which the logistics network is located, the size of the logistics network and other factors. Accordingly, different logistics networks can have different problem areas, such as critical connections between individual components of the logistics network or in incoming or outgoing processes.

Monitoring the utilization and functionality of the logistics network and individual sections of it can be an important aspect of logistics network operation. Monitoring can include the localization of problems, such as backlogs, and the associated elimination of identified problems.

Due to the different and individual design of various logistics networks, it is difficult to establish general rules for monitoring and it is usually necessary to adapt the monitoring to the respective logistics network. In the prior art, logistics networks are therefore usually monitored individually by experts trained for this purpose. These experts must take into account complex interrelationships, including, for example, the respective configuration, properties and parameters of the logistics network and their analysis. Problems are identified, for example, by inspecting individual sections of the logistics network. This often requires a considerable amount of manual work. In order to maintain an overview, status reports and dashboards are often used for manual monitoring, which are created and analyzed by the experts. An important criterion for effective and efficient monitoring is the experts' many years of experience with logistics networks in general and with the specific logistics network used in particular. Furthermore, the logistics network can also be dynamic. More specifically, a logistics network can change based on external influences or changes (e.g. material flows). This makes it particularly difficult for a person to have a complete overview of the logistics network.

The disadvantage is that newly commissioned logistics networks often have to be optimized step by step through experience during operation and that effective operation depends on the experience of experts.

It is therefore the object of the present invention to create a possibility with which the dependence on the experience of the operators of such logistics networks can be reduced for efficient operation. It would also be desirable to be able to put new logistics networks into operation with fewer or more quickly overcome individual initial problems compared to the current prior art.

### SUMMARY OF THE INVENTION

According to one aspect of the invention, a computer-implemented method for automatically monitoring a logistics network for processing mail items is provided. The method may comprise the following steps:
(a) Receiving or determining network properties of the logistics network,
(b) receiving or determining at least one actual operating value of the logistics network, and
(c) determining an anomaly value based on the at least one actual operating value and the network properties.

The method may, for example, be carried out by a control unit of a monitoring system. The control unit can be designed to carry out the steps of the method. Furthermore, the control unit can be designed to receive and process the required data and send commands. Mail items may include postal items, parcels, letters, envelopes and the like. Network properties may include properties relating to a structure of the logistics network. The network properties may be transmitted from elements of the logistics network to the control unit. The logistics network may comprise a transportation system configured to transport mail items. Furthermore, the logistics network may include a manipulation station for mail items. Here, the mail items can be gripped, rotated, sorted, stored, accelerated and/or decelerated. Such manipulation stations can have controls, actuators and sensors. The at least one actual operating value can comprise current operating parameters of the logistics network. The actual operating value may comprise operating parameters of at least one manipulation station and/or at least one transport system of the logistics network. The at least one actual operating value can be determined by being detected by a detection device. Additionally or alternatively, the actual operating value can also be obtained by a data query. The at least one actual operating value can be determined by determining it based on at least one other output value, in particular at least one current operating parameter and/or at least one operating parameter detected in the past. For example, actual operating values or output values can be detected by the detection device and sent to the control unit or the monitoring system. The detection device can be a camera, a scanner or a tactile sensor, for example. The detection device may be configured to detect the network properties and/or the at least one actual operating value. The anomaly value may be a binary value. For example, an anomaly value confirming an anomaly may be determined as soon as a maximum permitted load is exceeded at a point in the logistics network, e.g. at a node, an edge or a route (see explanations below). For example, the anomaly value can comprise the value “there is a problem” or “there is no problem”. Accordingly, the anomaly value can only assume two states (e.g. 1 or 0). A problem can be a defect, an overload and/or incorrect identification of mail items. A problem can be, for example, a hardware problem such as a defective motor, missing power supply or defective transfer parts. For example, identification may be faulty due to a defective or dirty barcode reader or a defective or dirty camera. A defect can also be dirt on a transport path, e.g. on a conveyor belt, or a blockage or backlog on a transport path. A defect can also be a control problem caused by a defective or faulty control system. A defect can be a defective insertion point. An insertion point is in particular a hardware element that aligns a mail item or places it in a designated position. An intended location can be, for example, a tray on a sorting unit. An insertion point can be defective, for example, if a light barrier is defective so that mail items are inserted incorrectly, or if a motor is defective. An overload can be, for example, an occupied destination node or an occupied end point. The anomaly value can have a plurality of anomaly gradations. Additionally or alternatively, the anomaly value may have a local reference to a section or a single element or a group of elements of the logistics network. For example, the anomaly value may have the local reference “relates to sorting item 1”. It may be provided that different types of anomaly values are provided for different elements or sections. Advantageously, by determining or receiving the network properties, the logistics network may be automatically recognized and, for example, its structure can be automatically determined.

By including at least one actual operating value when determining an anomaly value, automated problem detection can advantageously be enabled. Dependence on the individual knowledge of one or more experts can thus be reduced. The detecting of network properties, which is not yet common in the prior art and may be centralized, can enable rapid consideration and adaptation to the respective structure of a logistics network. This can be made possible in particular by the fact that both the actual operating value and the network properties are taken into account when determining the anomaly value. The method according to the invention can advantageously be applied to many different logistics networks. For example, capacities or transit times of parcel sorting systems or parcel networks can be monitored.

Preferably, the network properties comprise a topological structure of the logistics network. The topological structure can be indicative of the configuration or design of the logistics network. The topological structure may define the location and optionally the type of individual elements, e.g. processing units, of the logistics network. The type of individual elements may describe the processing of the elements with the mail items, in particular the processing of the mail items at these elements. Processing in this sense can include, for example, scanning, separating or sorting the mail items. The topological structure can be structured analogously to a network topology as known in the prior art. The topological structure can be a kind of map of the logistics network. The topological structure can reflect not only the location of certain elements, but also the properties of the elements. In addition, the topological structure can also reflect the operational properties of elements. This means that the topological structure can be advantageously used to automatically monitor a logistics network.

Preferably, the topological structure comprises edges and nodes. The nodes may be waypoints in the logistics network via which mail items can be transported. The points can represent an element in the logistics network at which the mail items are handled. The edges can be connections between the nodes on which mail items can be transported between two nodes. It may be possible to identify the edges and nodes based on the detection of at least one mail item. For example, it may be possible to detect a passage of the at least one mail item through the logistics network and use the path of the at least one mail item to draw conclusions about the nodes and edges or to derive the nodes and edges from them. Advantageously, edges and nodes can represent a simple way of structurally defining the logistics network. A monitoring system can be configured to automatically detect or derive the edges and nodes.

Preferably, the logistics network has at least one processing unit for processing mail items. The at least one processing unit may comprise an unloading unit, an identification unit, a conveying unit, a singulating unit, a separating unit, an injection unit and/or a sorting unit. The at least one processing unit can be provided at a node. The unloading unit can be a starting point of the logistics network at which a mail item can leave the logistics network or at which the mail item can be transferred to another section of the logistics network. Alternatively, the unloading unit can also be referred to as a drop-off point. The insertion unit can be an entry point of the logistics network at which a mail item can be inserted into the logistics network or at which the mail item can be inserted from one section of the logistics network into another section of the logistics network. The insertion unit can alternatively also be referred to as an insertion point. In particular, the separating unit can be designed to forward or be able to forward mail items in different directions. For example, the separating unit can be a separating diverter. The separating unit can also be referred to as a diverter. The separating unit can be designed to create a predefined minimum distance between several mail items, in particular in the direction of a transport path of the mail items. The sorting unit can be designed to sort mail items according to defined criteria. For example, it may be intended to sort mail items according to a categorization of their type, e.g. parcel/letter or according to weight classes, and/or their destination. The sorting unit can, for example, be part of a sorting center in the logistics network. The conveyor unit can be designed to enable transportation of the mail item. The identification unit can be designed to identify mail items. The identification unit can be or comprise, for example, a scan point and/or a detection device. For example, the identification unit can be designed to detect the presence or passing of a mail item. Additionally or alternatively, the identification unit may be designed to determine a type of mail item or information associated with the mail item. The information associated with the mail item can be, for example, an intended destination or a weight of the mail item. The monitoring system can be designed to use the identification unit to determine the network properties and/or the at least one actual operating value.

Preferably, the logistics network comprises a source node and a destination node, wherein at least one edge is provided between the source node and the destination node. It may be provided that the logistics network comprises several source nodes and/or several destination nodes. It may be provided that the source node and the destination node are dynamically assigned to the at least one mail item. For example, the source node can be an insertion unit via which the mail item is introduced into the logistics network. Alternatively, the source node can be a current location of the mail item, which is dynamically adapted to the current location of the mail item. The destination node can be an intended starting point, for example an unloading unit, via which the mail item is to leave the logistics network and/or to which the mail item is to be transported. As part of the method, it may be provided that the route of the mail item between a source node and a destination node is adjusted depending on the anomaly value. Advantageously, this can make it possible to flexibly adapt a transport or transport route of the mail item to the at least one actual operating value.

Preferably, the network properties are determined automatically by a monitoring system. The monitoring system can be designed to determine the network properties via at least one detection device. Additionally or alternatively, the monitoring system may be designed to retrieve the network properties from a processing unit. Advantageously, this embodiment can provide a particularly simple and time-efficient way of determining the network properties. In particular, independence from the expertise of corresponding specialists can be created.

Preferably, the network properties are determined by using at least one detection device to detect at least one mail item that is processed by the logistics network. The at least one detection device can be arranged on the processing unit or designed to detect the at least one mail item on the processing unit. The at least one detection device can, for example, be arranged on the identification unit, on the insertion unit and/or on the unloading unit or be configured to detect the at least one mail item at the respective unit. The monitoring system can be designed to derive the network properties from the detection of the at least one mail item. For example, the monitoring system can be designed to derive the network properties from a detected processing of the mail item, in particular comprising a transport route of the mail item. Advantageously, it is thus possible to use a mail item processing that is already taking place in order to determine required and/or useful information. Additionally or alternatively, it may be possible to determine or obtain the at least one actual operating value in an appropriate manner. Furthermore, at least two detection devices may also be provided. The at least two detection devices can detect mail items at different points in the logistics network. This makes it advantageously possible to recognize a material flow (e.g. of mail items) and then derive properties for edges from this.

Preferably, the network properties are detected in real time while the at least one mail item is being processed in the logistics network. Advantageously, this enables monitoring during real-time operation of the logistics network and thus, in particular, a particularly rapid response to errors or problems. It may be provided to automatically adjust processing in real time based on the determined anomaly value. In other words, the network properties can be obtained directly when the mail item passes through the logistics network.

Preferably, the at least one actual operating value of the logistics network relates to at least one mail item. It may be provided that the actual operating value is used to monitor the processing of the at least one mail item. In particular, the monitoring system can be designed to monitor and, if necessary, optimize the transport of the mail item, especially depending on the anomaly value. This enables particularly efficient monitoring and optimization of the processing of mail items by monitoring a single mail item and, if necessary, optimizing its processing.

Preferably, the anomaly value comprises a confirming anomaly value and a denying anomaly value, wherein a confirming anomaly value is indicative of the presence of an anomaly and a denying anomaly value is indicative of the absence of an anomaly. In other words, the anomaly value may comprise a digital statement (i.e. be indicative of only two statements). Advantageously, this can provide a relatively simple binary decision criterion. In the event of a confirming anomaly value, it may be provided to initiate a reaction measure or issue a command that triggers a reaction measure. In the event of a denying anomaly value, it may be possible not to initiate a reaction measure or to issue a reaction measure according to which dispatch is continued without adjustments.

Preferably, the at least one actual operating value comprises a number of mail items. In particular, a number of mail items can be a mailing quantity. The number of mail items may relate to a specific location, for example a specific node, a specific edge and/or a processing unit. For example, the number of mail items may be a number of mail items that currently or in a specific period of time occur or are processed at the specific location. The specific time period can be a time span. The time span may be in the past or a projected prediction for the future. Advantageously, a number of mail items can be used to detect congestion, in particular local congestion, in the logistics network.

Preferably, the at least one actual operating value comprises a transit time of the at least one mail item. The transit time can be a measure of how long the mail item is on a transport route. A transport route can be, in particular, the route between a source node and a destination node. Furthermore, the transit time can also be determined between other nodes or edges in the logistics network. It may be provided to determine the anomaly value by comparing the transit time with a threshold value. An anomaly value confirming an anomaly can be present if the threshold value for a maximum transit time is exceeded. Advantageously, it can thus be recognized if a mail item or several mail items are in transit for an unusually long time, which can be used in particular to draw conclusions about problems on the transport route.

Preferably, the at least one actual operating value comprises a parameter of a route of at least one mail item from a source node to a destination node of the logistics network. The route can be defined by edges and nodes of the logistics network. The parameter can be, for example, a mailing quantity on the route or a number of mail items on the route. The parameter can be a number of mail items on a section of the route. In particular, the section can be a node or an edge. The parameter can be a current average transit time of mail items on the route or on a section of the route, e.g. on an edge. The current average transit time can be determined over a defined period of time. The defined period of time can be of the order of a few seconds, e.g. 30 seconds, of a few minutes, e.g. 15 minutes, of hours, of days or of weeks. Advantageously, the respective parameter can thus be specified or specifically monitored. It may be provided that the actual operating value comprises several parameters.

According to an embodiment, the network properties comprise at least one operating value detected in the past. In particular, it may be provided that the actual operating value is compared with the at least one operating value detected in the past in order to determine the anomaly value. Advantageously, changes, in particular errors or problems, in the operating process can thus be detected relatively easily.

Preferably, the network properties comprise a target operating value. When determining the anomaly value, an absolute difference between the actual operating value and the target operating value can be determined as an operating value difference. Preferably, the operating value difference can be compared with a predetermined minimum deviation and the anomaly value can be indicative of whether or not the minimum deviation has been exceeded. Advantageously, unexpectedly large deviations from a standard defined by the target operating value can thus be detected effectively and relatively easily. The target operating value can, for example, be an average operating value determined over a certain period of time. The specified time period can preferably be before the time at which the actual operating value is determined. It may be intended to update the target operating value regularly in accordance with a predetermined number of defined time intervals, which together make up the specified time period. For example, a calculation of the target operating value can be based on an average value of several operating values from several time intervals. As time progresses, a new interval can be added to the calculation based on current operating values. Optionally, older time intervals can no longer be taken into account when calculating the average value. In particular, an older interval can be omitted for each new interval added. The actual operating value can correspond to the current or most recent interval. Advantageously, it is thus possible to recognize when the actual operating value deviates from previous operating values. The minimum deviation can be a predefined deviation tolerance from the target operating value, which the actual operating value should not exceed.

Preferably, a reaction measure can be carried out based on the anomaly value. In particular, the reaction measure can be designed to eliminate an anomaly corresponding to the anomaly value. It may be provided that the reaction measure is only carried out if the anomaly value confirms an anomaly or that the reaction measure “do not change” is carried out if the anomaly value negates an anomaly. Advantageously, it is thus possible to react appropriately to detected problems.

According to an embodiment, it is provided that several different actual operating values are determined for at least one of the mail items, which are related to this mail item, and are each compared with a target operating value. Several aspects can thus advantageously be taken into account as part of monitoring.

Preferably, the network properties comprise at least one distance measure. In particular, the distance measure can be or have been detected before the actual operating value. The distance measure can, for example, be an average transit time or average throughput time of mail items. The distance measure can be indicative of the transit time of a mail item from a specific node or a specific edge to another node or another edge. In particular, a transit time can be the time it takes for a mail item to be processed in the logistics network or the total time it takes to travel between the source node and the destination node. A throughput time can be a time in which a mail item is at a node or on an edge or between two successive nodes. The actual operating value can be a current operating value corresponding to the distance dimension, e.g. a current transit time or a current throughput time. In particular, it may be provided that the anomaly value is determined by comparing the distance measure with the actual operating value.

Preferably, the network properties comprise an average transit time of mail items detected in the past. According to an embodiment, it may be provided that, when receiving or determining network properties, transit times of mail items are detected by a monitoring system, and wherein the average transit time is determined before the actual operating value is determined.

Preferably, if the actual operating value deviates towards longer transit times above the average transit time, a confirming anomaly value is determined. The confirming anomaly value can in particular be confirming in such a way that the necessity of a reaction measure is confirmed.

According to an embodiment, the network properties comprise a distance measure for a plurality of available combinations of nodes of the logistics network. In other words, it may be provided that the distance measure is determined for a plurality of routes, each comprising a different combination of nodes. It may be provided to calculate alternative routes for the mail item as a reaction measure based on a comparison of different distance measures. Depending on the anomaly value, an optimized or at least improved route for the mail item can thus be determined.

According to an embodiment, the average transit time is detected for a large number of combinations of nodes in the logistics network. Advantageously, for example, an alternative route can be or can be determined from a plurality of detected routes, in particular by using the plurality of combinations as options.

Preferably, in step (c) or in the step for determining an anomaly value, the actual operating value is examined for a deviation from a transportation rule. The transport rule can, for example, be a standard transit time including a tolerance range, wherein the tolerance range must not be exceeded.

According to an embodiment, the transport rule includes that a mail item should not be transported through the logistics network for longer than a predetermined maximum total transit time. Advantageously, it can thus be quickly recognized if a transport of the mail item or several mail items takes longer than intended, which can in particular indicate problems in the logistics network.

Preferably, the actual operating value comprises a route of the mail items or of at least one of the mail items through the logistics network. For example, the nodes passed by the mail item(s) can be detected for a mail item(s). The route can be inferred from the nodes passed. For example, the route can include information about a destination node and a source node. For example, it can be determined whether a route between the destination node and the source node has an unusual characteristic. An unusual characteristic may be, for example, unusual in that it deviates from previously detected routes between the destination node and the source node. An unusual characteristic may include, for example, an unusual sequence of nodes on the route between the destination node and the source node compared to previously detected routes. An unusual sequence may include, for example, an unusually high number of nodes passed between the destination node and the source node. An unusual sequence may include, for example, an unusual transit time, in particular a particularly long transit time, between the destination node and the source node. Preferably, the actual operating value comprises a total transit time of at least one mail item through the logistics network. For example, it may be provided that the total transit time is compared to a target transit time to determine the anomaly value.

Preferably, the transportation rule includes that a mail item may not pass through any circular routes. Circular routes can exist if a problem or error prevents the mail item from being forwarded. A problem can be an overcrowded transport route or an end point, which prevents the mail item from being transported on to a destination node. An error can be incorrect forwarding, in particular forwarding in the wrong (always the same) direction, e.g. at a separating unit or at a separator. For example, a blocked destination node of a route or a sub-route can lead to the recirculation of one or more mail items. A sub-route can, for example, be a circular route of a sorting unit. A blocked destination node, e.g. a starting point, of the sorting unit can lead to recirculation on the circular route. As a result, mail items on the sorting unit in particular may have longer transit times through the sorting unit. Advantageously, such a problem or error can be detected with this embodiment.

Preferably, the anomaly value is determined based on a number of nodes that are passed by a mail item. The transport rule can state that no node may occur twice within a route. The latter would be expected for a circular route, for example. A double occurrence of a node can be an indication of an inefficient route.

Preferably, the anomaly value is determined based on a type of node that is passed by a mail item. For example, passing a certain type of node too often, e.g. passing a separating unit too often, may indicate an inefficient route. Advantageously, such an inefficient route can thus be recognizable.

Preferably, the logistics network comprises at least one anomaly detector, wherein the at least one anomaly detector is configured to determine an anomaly. Advantageously, the anomaly detector may be configured to automatically detect an anomaly value with respect to a mail item at at least one of a node, an edge and a route. Preferably, the actual operating value is transmitted to the at least one anomaly detector, wherein the at least one anomaly detector is designed to determine the anomaly value. An anomaly may be an incorrect or unscheduled handling or unplanned handling of a mail item. Advantageously, the anomaly detector can be a means of automatically determining an anomaly or the anomaly value. The anomaly detector may be generally designed to perform the determination of an anomaly value according to any of the embodiments described herein.

Preferably, the anomaly detector is designed to automatically determine a minimum deviation based on network properties and/or detection data from previous mail items, wherein the anomaly detector checks whether the actual operating value exceeds the minimum deviation and outputs an exceedance signal if an exceedance is detected. Detection data from previous mail items can be part of the network properties. For example, the acquisition data may be throughput times that have been registered in the past. Advantageously, the anomaly detector can be designed to detect anomalies based on past experience of the logistics network.

Preferably, the anomaly detector is designed to use a threshold-based method to detect the minimum deviation. A threshold-based method can be a method according to which the anomaly value is determined by comparing the actual operating value with a threshold operating value or with a target operating value range. A target operating value range is a range within which the actual operating value should lie. In particular, an actual operating value that lies outside the target operating value range can be classified as an anomaly. The threshold operating value is in particular a threshold value which the actual operating value must not exceed or, alternatively, which the actual operating value must not fall below. Accordingly, depending on the embodiment, an exceeding or falling below can be classified as an anomaly. The target operating value range or the threshold operating value can, for example, be understood as a definition for a tolerated deviation from an ideal value or normal value. The actual operating value can in particular be a transit time of at least one mail item.

Preferably, the at least one anomaly detector comprises a neural network trained with training data. The neural network can preferably be a deep neural network. A deep neural network is defined in particular by the fact that it comprises a plurality of intermediate layers between an input layer and an output layer. The neural network may have been trained with training data comprising the network properties of the logistics network, in particular nodes and edges of the logistics network, and actual operating values, e.g. transit times, as input. Reference data can be anomaly values assigned to the respective input. The anomaly values for the training can be determined manually by logistics experts, for example. Alternatively, archived logs from logistics networks, for example, can be used for training. The neural network can optionally be trained to predict the future behavior of actual operating values. For example, actual operating values of the same mail items at different points in time from the past can be used as training data for this purpose. In particular, a neural network can be a good way of flexibly adapting to different logistics networks. Alternatively, the neural network can also be implemented as hardware, for example with fixed connections on a chip or another computing unit. The computing unit that can carry out the method according to the invention can be any computing unit such as a CPU (Central Processing Unit) or GPU (Graphics Processing Unit). The computing unit may be part of a computer, a cloud, a server, a mobile device such as a laptop, tablet computer, cell phone, smartphone, etc.

Preferably, the training data comprises annotated time points for anomalies. The annotation (i.e. the annotated time points) characterize the respective normal or anomaly status of a part in the logistics network (e.g. a plant part) with a so-called label (classification), which can be advantageously used for training machine processes (so-called supervised ML).

Preferably, the at least one anomaly detector is designed to use a cluster-based method to determine the anomaly value. Cluster-based methods can be unsupervised ML methods in which, for example, groups of similar data points are formed using feature vectors based on a distance measure. Data points can also be assigned to not clearly specified clusters. In this case, we speak of outliers or anomalies. This offers the advantage that results can also be generated in a case where there are ambiguous measured values. An optimum result can then be approximated by repeating the process several times.

Preferably, the at least one anomaly detector is designed to use a statistical method to determine the anomaly value. For example, a variance of historical operating values can be used to determine a target operating value range or an upper or lower threshold value. For example, the anomaly detector may be designed to continuously detecting operating values and use the operating values to determine a standard deviation or a predetermined multiple of a standard deviation and classify an exceedance of the standard deviation as an anomaly.

In other words, statistics can be formed on the observed values (e.g. average, median, variance, hourly deviation, distribution, etc.). The statistics can then be compared with the respective actual values in order to define and recognize an anomaly.

Preferably, the at least one anomaly detector comprises a cyclic detector which is designed to detect a cyclic behavior of the at least one actual operating value during successive measurements by the cyclic detector. Cyclical behavior can be present if operating values change cyclically in a recurring or similarly recurring manner. For example, some operating values may be typical for certain times of day or for different days of the week and therefore recur cyclically. Advantageously, these time-dependent patterns can thus be taken into account in the evaluation.

Preferably, the at least one anomaly detector is designed to monitor transit times of mail items. In particular, the anomaly detector may be designed to monitor transit times as generally described herein in the context of the method.

Preferably, neighboring nodes, edges and/or routes are aggregated to determine a starting point of the anomaly. Aggregating may mean that the neighboring nodes, edges and/or routes are grouped into sections. It may be intended to determine anomaly values for the aggregated sections. If it is determined that a section has an anomaly, it may be necessary to divide the section back into its individual parts, i.e. in particular into individual nodes, edges and/or routes, and to determine an anomaly value for each individual part. For example, a throughput time can be determined by a section. If the throughput time for this section is unusually long, the throughput time can be determined individually for each node of this section in order to determine the exact cause of the longer throughput time. Advantageously, by simplifying the problem, aggregation can enable the application of a less extensive algorithm and save computing time, for example.

Furthermore, detected values can also be aggregated within different time intervals. For example, all measurements within a 5-minute interval can be summarized in order to calculate the anomalies on the basis of the aggregate. In this way, the amount of data can be reduced and an efficient evaluation can be provided.

Preferably, the method further comprises the step of: performing at least one reaction measure based on the anomaly value. It may be provided that the reaction measure is only performed for some anomaly values, in particular for anomaly values that indicate a problem, an error or an anomaly. Anomaly values that confirm normal operation generally do not require a response. In such a case, the reaction measure can be aimed at ensuring that no change is necessary or that normal operation continues as before. Advantageously, the reaction measure can be used to react automatically to problems or anomalies, allowing faulty operation to be corrected more quickly.

Preferably, the reaction measure comprises redirecting a mail item to an alternative route. This can be particularly advantageous if it is determined on the basis of the actual operating value that an alternative route enables a shorter transit time. Alternatively, it can be determined that a current route is overloaded, while the alternative route still has more capacity. The alternative route may be selected based on the fact that it allows a shorter transit time of the mail item to the destination node than the planned route. The alternative route may be selected to have a lower planned mail item volume than the planned route and, optionally, that at the same time the transit time via the alternative route does not exceed a predetermined additional transit time compared to the originally planned route. Advantageously, it can therefore be possible to automatically optimize the transit time in real time by reacting to a current status of the logistics network. Preferably, a current mail item is checked for an anomaly on the planned route at a number of nodes of the logistics network, each of which comprises a separation unit, as the mail item passes through, and if an anomaly is detected, the mail item is rerouted as a reaction measure at the respective current node of the number of nodes at which the mail item is currently located. Preferably, the alternative route is calculated in such a way that the transit time of the mail item is minimized. It may be intended to minimize the transit time for a mail item based on the determined actual operating value. Preferably, the transit time of the mail item is calculated by the alternative route based on transit times of mail items in a predetermined period of time in the past. For example, an average transit time of mail items in a just past period of defined length can be determined in order to determine the transit time of a route or several routes. It may be provided that, if there are no detected transit times of a route in the determined time period, an average transit time of the last known time interval is used by having a detected transit time. Preferably, the alternative route is calculated such that nodes or sub-routes from which no signals from mail items were received in a predetermined previous time period are not part of the alternative route. It is possible that no mail items were traveling in these nodes or sub-routes during this period of time and therefore no signals were received. This may be due to the fact that the corresponding nodes or sub-routes have a fault. It may therefore be advantageous not to take the corresponding routes into account. Alternatively, it may be preferable to check whether the route is free or whether there is a fault for nodes or sub-routes for which no signals from mail items have been received. If the route is free, an average transit time of the last known time interval can be used, for example, by having a detected transit time.

Preferably, the actual operating value is an estimated future load of nodes, edges and/or routes of the logistics network via which at least one mail item is to be transported or dispatched as scheduled. For example, a course of several known current mail items on their respective routes can be projected into the future in order to enable a prediction or estimation of a future load. In other words, for example, information from past load volumes can be used to determine the actual operating value in order to estimate the volume of as yet unknown mail items in the future. Similarly to determining an anomaly value based on the current status, it may be possible to estimate an anomaly value for the future. Advantageously, possible future problems such as backlogs, overflows or terminal fill levels at the destination node can thus be detected at an early stage. It may be possible to initiate a reaction measure before the problem has actually occurred. A reaction measure can be, for example, the rerouting of at least one mail item to an alternative route. Alternatively, a reaction measure can be, for example, the short-term provision of additional capacities, in particular transport capacities, e.g. additional nodes or edges. Preferably, the estimation of the future load can be performed using a prediction model based on machine learning.

Another aspect of the invention is a monitoring system comprising a control unit, wherein the control unit is configured to perform a method as described herein for monitoring the logistics network. All advantages and features of the method for automatic monitoring can be transferred analogously to the monitoring system and vice versa. Preferably, the monitoring system comprises a detection device for detecting operating values of a logistics network, wherein the detection device is connected to the control unit and is configured to transmit detected operating values to the control unit. The detection device can, for example, be integrated in a node of the logistics network. The detection device may, for example, comprise a camera or a scanner, e.g. a barcode scanner. Preferably, the monitoring system can comprise an output interface connected to the control unit for outputting a response measure. The output interface may, for example, be connected to the nodes of the logistics network. The control unit may be configured to initiate a rerouting of mail items. The control unit may be configured to issue a message to operators or monitoring personnel of the logistics network.

Another aspect of the invention is a logistics network comprising a monitoring system as described herein. All advantages and features of the method for automatic monitoring and the monitoring system can be transferred analogously to the logistics network and vice versa.

According to a further aspect of the present invention, there is provided a computer program comprising instructions which, when the program is executed by a computing unit, cause the computing unit to execute the method according to any of the previous embodiments.

The invention also relates to a computer-readable medium comprising instructions which, when executed by a computing unit, cause the computing unit to carry out the method according to the invention, in particular the above method or the further forming method. Such a computer-readable medium can be any digital storage medium, for example a hard disk, a server, a cloud or a computer, an optical or a magnetic digital storage medium, a CD-ROM, an SSD card, an SD card, a DVD or a USB or other memory stick.

According to another aspect of the present invention, a method for training an artificial neural network for anomaly detection in a logistics network for mail items is provided, comprising the steps of:
Receiving input training data, namely network properties of the logistics network and at least one actual operating value of the logistics network,
Receiving output training data, namely at least one anomaly value. The training can be a first-time training of a neural network or a retraining of an existing neural network. Variables within the neural network can be adapted so that input training data matches the output training data (“matching”). The variables can cause the transformation from the input data to the output data. Once the variables have been adapted (i.e. the neural network has been trained), an anomaly value can be output together with at least one actual operating state when network properties of the logistics network are inputted. A deployed neural network can also be further trained during operation by flagging false outputs as such and adjusting the variables of the neural network accordingly.

Individual features or embodiments can be combined with other features and other embodiments to form new embodiments. All embodiments and advantages then also apply to the new embodiments. All advantages mentioned in relation to the method also apply analogously to the device and vice versa. In particular, all advantages and features of the method for automatic monitoring, the monitoring system, the logistics network and the computer program can be transferred analogously to the method for training a neural network and vice versa.

### BRIEF DESCRIPTION OF THE DRAWINGS

Further advantages and features of the present invention are apparent from the following description with reference to the figures. Individual features disclosed in the embodiments shown may also be used in other embodiments, unless expressly excluded. The figures show

FIG. 1 is a flowchart of a method for automatically monitoring a logistics network for processing mail items according to an embodiment of the invention;

FIG. 2 is a representation of a logistics network with a monitoring system according to an embodiment of the invention; and

FIG. 3 is a schematic representation of a logistics network according to an embodiment of the invention.

### DETAILED DESCRIPTION OF THE PREFERRED EMBODIMENTS

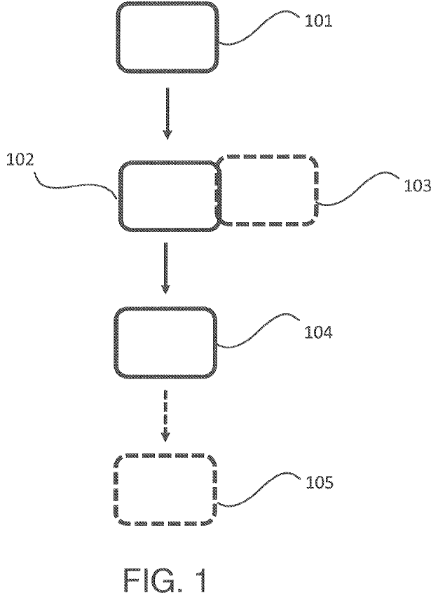

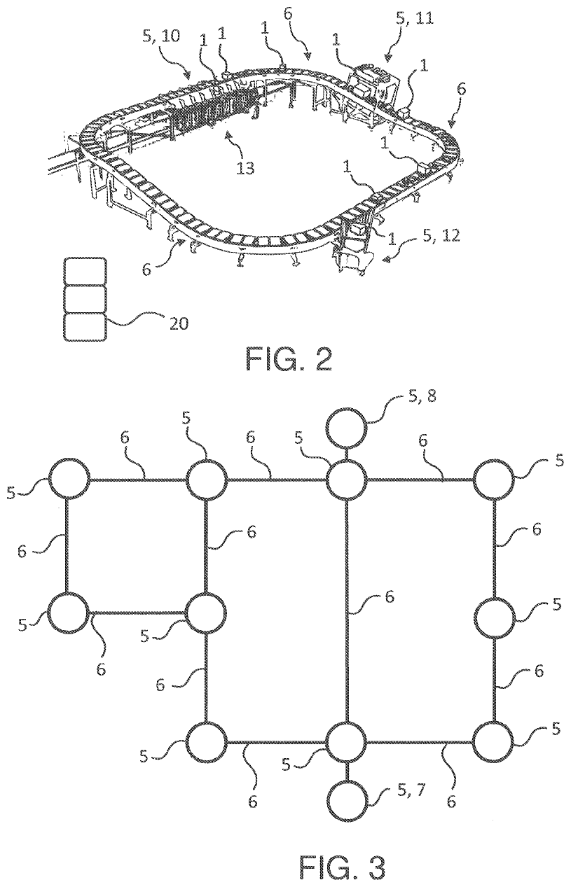

FIG. 1 shows a flowchart of a method for automatically monitoring a logistics network for processing mail items 1 according to an embodiment of the invention. The method can, for example, be carried out by a central control unit 20 (see FIG. 2) or a central monitoring unit. In a first step 101, network properties of the logistics network are received or determined. The network properties can preferably comprise a topological structure. The topological structure may comprise nodes 5 and edges 6 (see FIG. 2), wherein the edges 6 are in particular connections between nodes 5. It may be provided to define a source node 7 and a destination node 8 for each edge 6, wherein the source node 7 may in particular be a starting point of a route of a mail item 1 to be transported and the destination node 8 may in particular be a destination point of the route of the transported mail item 1. The topological structure can comprise topological properties, such as, for example, a detected mail quantity, a distance measurement or a detected time measurement of transit times of the mail items 1. The topological properties can, for example, be detected via one or more detection devices. The one or more detection devices can, for example, be arranged at detection points of a sorting system of the logistics network. The detection devices can, for example, be arranged at scanning, insertion or discharge points or other points of the logistics network. It may be provided to detect the topological properties in real time. For example, time units or time intervals can be defined and the topological properties are detected for each time unit or each time interval. In addition, the route through the logistics network can be detected for at least one mail item 1, preferably for several or each mail item 1. In particular, various possible routes, preferably all possible routes on which mail items 1 are transported, can thus be detected. In particular, the topological properties on these routes can also be detected and optionally assigned to the routes. In this step, operating values can also be determined over a certain period of time, in particular continuously, wherein the operating values can include topological properties, for example. Target operating values can be determined from the detected operating values, for example by forming mean values of operating values over a certain period of time, e.g. over a week.

In a further step 102, at least one actual operating value of the logistics network is received or determined. An actual operating value is, in particular, an operating value that is present or determined at the respective current time. The actual operating value may, for example, be a currently determined transit time of a mail item 1. Alternatively or additionally, the actual operating value can also comprise a route intended for a current mail item 1. In a modified or additional variant of this step 103, the actual operating value may also be an estimate of the future based on current values, e.g. based on current operating values. In particular, a load of nodes 5, edges 6 and/or routes of the logistics network can be estimated in the future.

In a further step 104, an anomaly value is determined based on the at least one actual operating value and the network properties. In a simple embodiment, the anomaly value can, for example, assume the two values “anomaly is present” and “anomaly is not present”. This can be done, for example, by comparing the actual operating value with the target operating value, wherein the target operating value can be used in particular to define a threshold value, the exceeding of which is automatically evaluated as an anomaly by the actual operating value. This step can be carried out by an anomaly detector, for example. Alternatively or additionally, the actual operating value can be compared with a defined rule. For example, a rule may be that mail items 1 should not pass through any circular routes, i.e. in particular no routes in which individual nodes 5 are passed several times. A violation of such a rule can be automatically evaluated as an anomaly.

In an optional further step 104, it may be provided to perform at least one reaction measure based on the anomaly value. In particular, the reaction measure may be designed to eliminate a detected anomaly.

FIG. 2 shows a representation of a logistics network with a monitoring system according to an embodiment of the invention. The monitoring system comprises a control unit 20 configured to execute a method for automatically monitoring a logistics network for processing mail items 1 as described herein. The logistics network comprises a plurality of edges 6 and nodes 5 for processing the mail items 1. The nodes 5 may be, for example, a sorter (i.e. sorting unit) or sub-points in the sorter such as drop points 10 or identification units 11. Furthermore, the nodes 5 can comprise insertion units 12 and unloading units 13. The edges 6 are the connections between the various nodes 5. In particular, the edges 6 in this example are represented by conveyors. Detection devices are arranged at each of the various nodes 5 (not shown), which can detect the mail items 1 and operating values as they pass. The detection devices are connected to the control unit 20 and transmit detected operating values or information from which operating values can be derived to the control unit 20. In particular, the control unit 20 is designed to initiate a reaction measure if an anomaly is detected.

In a further embodiment not shown, the logistics network comprises one or more branches (e.g. flow splitters) or transfer points of several circular sorters and redundant routes. Analogous to the above embodiment, the points can again be defined at stations (e.g. branches, transfer points, etc.) or at sub-points of a station. The edges can then connect the points.

FIG. 3 shows a schematic representation of a logistics network according to an embodiment of the invention. Between a source node 7 and a destination node 8, there are several possible routes that a mail item 1 can take to get from the source node 7 to the destination node 8 via several nodes 5 and edges 6.

### LIT OF REFERENCE SIGNS

1 Mail items
5 Nodes
6 Edge
7 Source node
8 Destination node
10 Drop point
11 Identification unit
12 Insertion unit
13 Unloading unit
20 Control unit

1.-38. (canceled)

39. A computer-implemented method for automatically monitoring a logistics network for processing mail items, comprising:
receiving or determining network properties of the logistics network;
receiving or determining at least one actual operating value of the logistics network; and
determining an anomaly value based on the at least one actual operating value and the network properties.

40. The method according to claim 39, wherein the logistics network comprises a source node and a destination node, wherein at least one edge is provided between the source node and the destination node.

41. The method according to claim 39, wherein the network properties are determined by detecting, by at least one detection device, at least one mail item that is processed through the logistics network.

42. The method according to claim 39, wherein the at least one actual operating value of the logistics network concerns at least one mail item and comprises a route of the mail items through the logistics network.

43. The method according to claim 39, wherein the anomaly value comprises a confirming anomaly value and a denying anomaly value, and wherein a confirming anomaly value is indicative of a presence of an anomaly and a denying anomaly value is indicative of a non-presence of an anomaly.

44. The method according to claim 39, wherein the at least one actual operating value comprises a parameter of a route of at least one mail item from a source node to a destination node of the logistics network.

45. The method according to claim 39, wherein the network properties comprise at least one operating value detected in the past.

46. The method according to claim 39, wherein the network properties comprise a target operating value.

47. The method according to claim 39, wherein the network properties comprise at least one distance measure.

48. The method according to claim 39, wherein the actual operating value is examined for a deviation from a transportation rule when determining the anomaly value.

49. The method according to claim 48, wherein the transportation rule comprises that a mail item is not allowed to go through circular routes.

50. The method according to claim 39, wherein the logistics network comprises at least one anomaly detector, wherein the at least one anomaly detector is configured to determine an anomaly.

51. The method according to claim 50, wherein the anomaly detector is configured to automatically determine a minimum deviation based on network properties and/or detection data from previous mail items, wherein the anomaly detector checks whether the actual operating value exceeds the minimum deviation and outputs an exceedance signal if an exceedance is detected.

52. The method according to claim 50, wherein the anomaly detector is configured to use a threshold-based method to detect the minimum deviation.

53. The method according to claim 50, wherein the at least one anomaly detector comprises a neural network trained with training data.

54. The method according to claim 50, wherein the at least one anomaly detector is configured to use a cluster-based method to determine the anomaly value.

55. The method according to claim 50, wherein the at least one anomaly detector is configured to use a statistical method to determine the anomaly value.

56. The method according to claim 50, wherein the at least one anomaly detector comprises a cyclic detector configured to detect a cyclic behaviour of the at least one actual operating value in successive measurements by the cyclic detector.

57. A computer program, comprising:
instructions which, when the program is executed by a computing unit, cause the computing unit to execute the method according to claim 39.

58. A method for training an artificial neural network for anomaly detection in a logistics network for mail items, comprising:
receiving input training data including network properties of the logistics network and at least one actual operating value of the logistics network; and
receiving output training data including at least one anomaly value.
